(19) United States
(12) Patent Application Publication
(10) Pub. No.: US 2010/0072178 A1
(43) Pub. Date: Mar. 25, 2010

(54) METHOD AND DEVICE FOR LASER WELDING

(76) Inventor: Reiner Ramsayer, Schwieberdingen (DE)

Correspondence Address: KENYON & KENYON LLP, ONE BROADWAY, NEW YORK, NY, 10004, US

(21) Appl. No.: 12/526,629

(22) PCT Filed: Jan. 4, 2008
(86) PCT No.: PCT/EP08/50056

§ 371 Date: Dec. 2, 2009

(51) Int. Cl. B23K 26/00

(52) U.S. Cl. 219/121.64; 219/121.63

(57) ABSTRACT

A method for joining materials by laser radiation is provided. The laser radiation is focused onto a focal area, which is small compared to a working area, and a specifiable intensity distribution is achieved over the working area by moving the focal area across the working area. Also provided is a device for joining materials by laser radiation, a focal area of the laser radiation, which is small compared to a working area, being movable across the working area with the aid of movable optical components, and a disk laser or a fiber laser being provided as the source of radiation. The method and the device may make it possible to set almost any intensity distribution over a working area, thus to achieve a reproducible welding process adapted to the joining task.

### FIELD OF INVENTION

The present invention relates to a method and a device for joining materials by laser radiation.

### BACKGROUND INFORMATION

Today, in laser welding, the material or materials to be joined, usually metals, are irradiated by a focused laser beam and are thereby heated and melted.

By a high intensity of irradiation it is possible to achieve an at least partial vaporization of the material. This results in the formation of a vapor capillary, the so-called keyhole. The method is commonly termed keyhole welding or deep welding.

An essential quality characteristic in deep welding is the stability of the developing keyhole. It has a decisive influence on the reproducibility of the process, the development of the melting bath and the distribution of the alloy elements in the weld bath when joining materials of different kinds or when welding using additive materials.

German Patent Reference DE 197 51 195 C1 appears to describe a method for welding by laser radiation, using at least one laser beam, in which the intensity of the laser radiation is adjusted by beam shaping in and on the surface of workpieces in such a way that a small region is irradiated at great intensity in the workpiece so as to form in that region a vapor capillary and another greater adjacent region is irradiated at lower intensity on the workpiece surface in such a way that a cup-shaped opening of the vapor capillary is formed on the workpiece surface and the cooling rate of the melt is reduced, the position and/or orientation of the axes of at least two laser beams or partial beams to the workpiece surface are varied with respect to one another as a function of temperature while carrying out the welding method. The document furthermore describes a device for implementing the method, in which a laser beam of a laser beam source is directed onto a beam splitter and two beam components are directed onto two beam-shaping units and with the aid of a beam shaping unit a highly focused beam component is directed onto the workpiece, which is overlapped by the second defocused beam component, at least one temperature sensor measures the temperature distribution on the workpiece and the temperature sensor(s) is/are connected to a control unit controlling the laser beam sources and/or the beam shaping units, which changes the position and/or the orientation of the axes of the beam components with respect to the material surface as a function of the temperature distribution as the welding method is carried out.

A disadvantage of this method or device is the fact that complex and thus expensive optical components are required for adapting the intensity distribution to the welding task, e.g., if the intensity distribution is to be varied during the welding process as a function of the measured temperature distribution in the welding point. For this purpose, the intensity distribution is limited to patterns that may be achieved by two overlapping focal areas of circular or oval cross section.

Another disadvantage of the method is that the focal plane lies in a definitively specified working plane, which cannot be changed during the welding process. It is therefore not possible to adapt the intensity distribution to the joining task perpendicularly to the focal plane.

### SUMMARY

An embodiment of the present invention is to provide a method that allows for setting an intensity distribution that is adapted to the welding task in a working area. An embodiment of the present invention is to provide a corresponding device.

An embodiment of the present invention with respect to the method includes focusing the laser radiation onto a focal area that is small compared to a working area and achieving a specifiable intensity distribution over the working area by moving the focal area across the working area. The method makes it possible to set a nearly arbitrarily selectable average intensity distribution within the working area merely by specifying the movement of the focal area. The movement and thus the intensity distribution may be changed at any time by appropriately controllable optical components that deflect the laser beam, without having to provide for a change of optical components. A device operated in accordance with the method may therefore be adapted very quickly to changing welding tasks. In addition to the intensity distribution within the working area, the contour of the working area within the resolution predetermined by the size of the focal area and the heat conduction of the mating parts may be freely specified.

Exemplary variants of an embodiment of the present invention provide for the specifiable intensity distribution over the working area to be produced by different dwell times of the focal area on parts of the working area and/or by different intensities of the laser radiation as a function of the position of the focal area within the working area and/or by a different frequency with which the focal area is run across parts of the working area. The variants and combinations of the variants allow for the average energy introduced per section of the working area to be varied. Thus the focal area may be run accordingly more often or more slowly across areas of high required intensity than across areas of low required intensity or the intensity of the laser radiation may be set as a function of the position of the focal area accordingly high in areas of high required intensity and accordingly low in areas of low required intensity.

Provision is made to produce working areas in a range of magnitude from 150 μm to 600 μm through focal areas of 10 μm to 100 μm, e.g., from 10 μm to 20 μm, and/or to produce working areas that are larger by a factor of least eight than the focal area, it thus being possible to achieve intensity distributions of sufficient resolution within working areas available in laser welding.

Different intensity distributions within the working area may be achieved in that the movement of the focal area across the working area occurs along freely specifiable paths and/or in grid-shaped fashion. In the case of freely specifiable paths, the desired intensity distribution at a uniform intensity of the laser radiation and path speed of the focal area may be set by an appropriate selection of the path of movement, while in the case of a grid-shaped movement of the focal area, the intensity of the laser radiation or the speed of the movement of the focal area must be varied.

An extended weld seam between the mating parts is achieved by moving the working area along a joining line.

A freely selectable and quick movement of the focal area within the working area may be achieved in that the movement of the focal area is effected by scanner mirrors situated in a beam path of the laser radiation and/or by moving wedge plates and/or moving roof mirrors and/or moving lenses.

In order to be able to conduct the welding process in a reproducible manner there may be a provision for the movement of the focal area across the working area to occur so quickly that for the process a nearly stationary intensity distribution across the working area is achieved. The temperature stability within a point of the working area is thus established from the frequency with which the focal area per unit in time is run across the point and the heat conduction from or to the point.

If there is a provision for the focus of the laser radiation to be able to be adjusted along the propagation direction of the laser radiation, then it is also possible to adjust the intensity distribution into the depth of the workpieces to be joined. Thus is it possible to achieve specifically three-dimensional intensity distributions for example in deep welding.

For this purpose it may be particularly advantageous if the laser radiation is focused on the surface of a developing keyhole. Thus it is possible to work on any working location with the most favorable focal position.

The possibility of varying the focal position in the beam direction furthermore allows for the size of the focal area to be adjusted. This results in another possibility of specifically varying the intensity distribution on the workpiece surface within the working area.

In cw seam welding it may be useful to introduce more energy on the welding front so as to produce slim and deep weld seams. Thus one may set a high intensity of laser radiation in a front section of the working area, viewed in the working area's direction of movement.

In deep welding, the formation of a suitable keyhole is especially important. In this connection, for example, it is possible to facilitate the discharge of developing gaseous components by a suitable geometry of the developing keyholes, which makes it possible to avoid jams and spraying. An embodiment of the present invention therefore provides for the intensity distribution to be set so as to form a geometry of a developing keyhole that is optimized for the welding task. For this purpose, both the intensity distribution in the plane of the working area as well as in the depth may be specified accordingly. For the purpose of developing a suitable keyhole, a sickle-shaped region of high intensity may be produced for example within the working area, the crown of the convex curvature of the sickle-shaped region pointing in the direction of welding, that is in the direction of the movement of the working area.

Particularly for joining materials of different kinds there may be a provision for setting the intensity distribution over the working area in such a way that a high intensity of laser radiation acts on one mating part and a lower intensity of laser radiation acts on a second mating part. When joining materials of different kinds it may thus be useful if one of the two mating parts is merely melted, whereas the second mating part must be melted and partly vaporized. Thus it is possible to join materials having very different melting and vaporization temperatures, which is difficult to do using a homogeneous intensity distribution. This opens up new possibilities when joining such material combinations, which hitherto presented critical cases in terms of their weldability.

An embodiment of the present invention provides for the intensity distribution across the working area to be set so as to set specifically an intermixture of the melting bath. This may also mean that the intermixture of the melting bath is prevented at least as far as possible. In seam welding, using additive materials that the intermixture of the melting bath is greatly influenced by the intensity distribution and the flows in the melting bath induced thereby. By optimizing the melting bath intermixture it is possible for the additive material to be distributed homogeneously in the microstructure or to be specifically accumulated in certain regions in the welding bath so as to bring about certain properties in the microstructure of those regions. By specifically setting the direction of flow and the rate of flow in the melting bath in combination with a suitable shape of a developing keyhole, the welding process may be stabilized markedly and the shape of the seam may be designed according to the requirements.

If there is a provision for the intensity distribution to be set in the context of a control loop on the basis of measured conditions in the working area, then it is possible specifically to vary and set the welding parameters directly during the welding process. Imperfections may be detected by suitable sensors and removed by adjusting the intensity and intensity distribution.

Thus there may be a provision to take into account, as conditions in the working area, a melting bath flow and/or gap widths between mating parts. The melting bath flow may be detected by appropriate sensors and always set in an optimized manner using an appropriate control loop via the intensity distribution across the working area in order to achieve processes of high reproducibility and quality. Furthermore, a gap between two mating parts in the butt joint may be detected and the intensity distribution may be designed in such a way that the two mating parts are exposed to a higher beam intensity than the gap. The laser beam thus does not break through, as may happen in conventional laser welding methods using a fixed intensity distribution, and the gap is able to close. Furthermore, the ability to bridge a gap increases as well. Using suitable sensors it is possible always to adjust the working area most favorably to the position of the mating parts, even when the quality of the joint edges is imprecise.

An embodiment of the present invention with respect to the device is achieved in that a focal area of the laser radiation that is small compared to the working area is movable across the working area with the aid of movable optical components and that a disk laser or a fiber laser is provided as the source of radiation. For this purpose, in particular scanner mirrors used as movable optical components allow for a quick and freely programmable path movement. Because of their very high beam quality, disk lasers and fiber lasers allow for the formation of very small focal areas such as are required for implementing the described method. Thus, using a fiber laser for example, it is possible to achieve focal areas of only a few μm in diameter.

### BRIEF DESCRIPTION OF THE DRAWINGS

FIG. 1 shows a schematic representation of a first laser welding system according to the related art.

FIG. 2 shows a schematic representation of a second laser welding system according to the related art.

FIG. 3 shows a schematic representation of a working area having a homogeneous intensity distribution.

FIG. 4 shows a schematic representation of a working area having a non-homogeneous intensity distribution.

FIG. 5 shows a schematic representation of another working area having a non-homogeneous intensity distribution.

FIG. 6 shows a schematic representation of another working area having a non-homogeneous intensity distribution.

FIG. 7 shows a schematic representation of another working area having a non-homogeneous intensity distribution.

### DETAILED DESCRIPTION

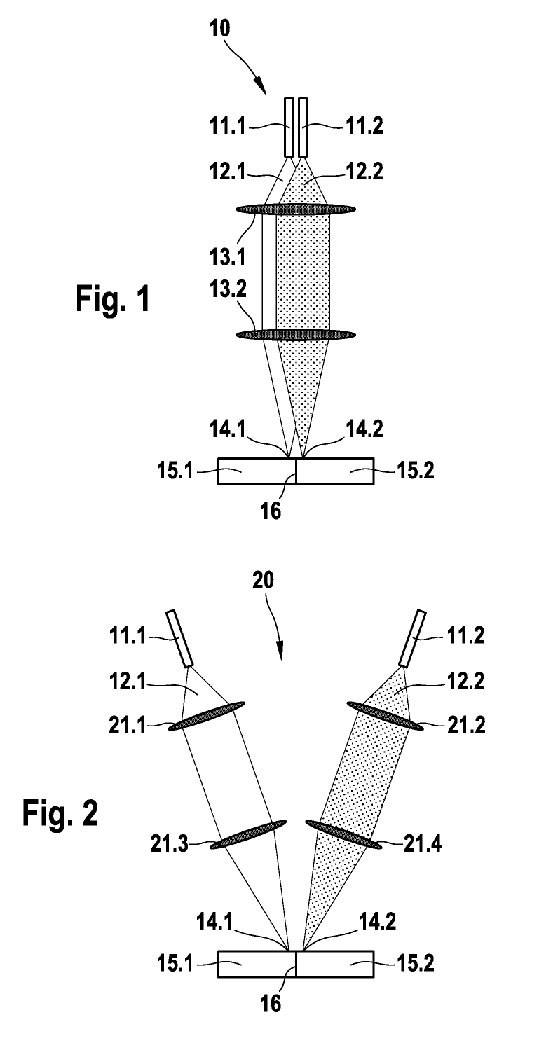

FIG. 1 shows a schematic representation of a first laser welding system 10 according to the related art. Using a first light guide 11.1, a first laser beam 12.1 is guided, and using a second light guide 11.2, a second laser beam 12.2 is guided to a first shared lens 13.1 and subsequently to a second shared lens 13.2 and focused on the surface of a first mating part 15.1 and of a second mating part 15.2 in the region of a joining line 16. Laser beams 12.1, 12.2 respectively form one focal point 14.1, 14.2 extended in area on the surface of mating parts 15.1, 15.2.

Laser beams 12.1, 12.2 heat and melt mating parts 15.1, 15.2 in the region of joining line 16 such that mating parts 15.1, 15.2 are joined.

Due to the planar extension of focal points 14.1, 14.2, these may be at least partially superposed. In the overlapping region there then exists a high beam intensity compared to a non-superposed region. By specifically superposing focal points 14.1, 14.2, it is possible to provide a desired intensity distribution within an irradiated working area. The intensity distribution may be varied by the position and the ratio of the overlapping to the non-overlapping regions, by different beam intensities between first and second laser beam 12.1, 12.2 and/or by differently sized focal points 14.1, 14.2.

FIG. 2 shows a schematic representation of a second laser welding system 20 according to the related art. In this instance, identical components are indicated as introduced in FIG. 1.

In contrast to the exemplary embodiment shown in FIG. 1, the beam paths of first laser beam 12.1 and second laser beam 12.2 are guided separately. First laser beam 12.1 is focused by a first front lens 21.1 and a first rear lens 21.3 and second laser beam 12.2 is focused by a second front lens 21.2 and a second rear lens 21.4 onto the surface of the two mating parts 15.1, 15.2.

In addition to the options for setting an intensity distribution mentioned in FIG. 1, it is possible to vary the geometry of focal points 14.1, 14.2 from approximately circular to oval by inclining the beam axes of laser beams 12.1, 12.2, which results in additional options for the settable intensity distributions.

The advantage of laser welding systems 10, 20 having two focal points 14.1, 14.2 shown in FIGS. 1 and 2 is that welding processes may be conducted in a clearly more reproducible fashion due to the adjustable intensity distributions within the working area. Thus, for example, it is possible to optimize the shape of a developing keyhole when deep welding.

A disadvantage in the shown laser welding systems 10, 20 is the fact that for system-related reasons the intensity distributions lie in a fixed working plane, the focal plane, which cannot be modified during the process. On the other hand, the distribution of the intensity, is not modifiable or modifiable only to a limited extend during the process even when using special optics.

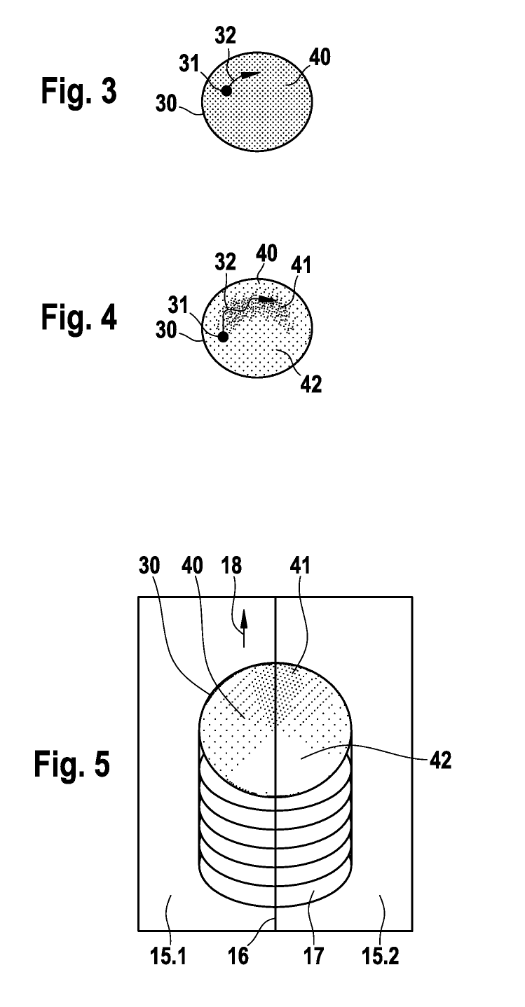

FIG. 3 shows a schematic representation of a working area 30 having a homogeneous intensity distribution 40 as may be produced according to the present invention. In this instance, intensity distribution 40 is indicated by the density of the displayed dots, a high density of dots corresponding to a high intensity. Within working area 30, a focal area 31 of a laser radiation (not shown) is depicted, which is distinctly smaller compared to working area 30 and is moved along a specified path movement 32 within working area 30.

The size of working area 30 corresponds approximately to the overlapping focal points 14.1, 14.2 produced in known laser welding systems 10, 20 and typically lies in the order of magnitude of 150 μm to 600 μm. To achieve the comparatively very small focal area 31 in the order of magnitude of 15 μm for example requires beam sources of high beam quality. Fiber lasers or disk lasers may be used for this purpose. Thus, using a fiber laser, it is possible to achieve focal areas 31 in the range of a few μm.

If a working area 30 is scanned rapidly with the aid of such a beam source and a small focal area 31, it is possible to achieve any geometry of working area 30, even one deviating from a round or oval surface area, for example, having a rectangular, triangular or linear surface area. Because of the speed of the movement of focal area 31 or the dwelling time of focal area 31 over a section of working area 30, the average intensity may be scaled across the scanned region. This makes it possible to adapt the power distribution in working area 30 to the working task. Using suitable control algorithms it is furthermore possible to control and adapt intensity distribution 40 always in an optimized manner during the welding process.

For the method it is important that the movement of focal area 31 occurs in such a way that the process achieves a quasi constant intensity distribution 40 over working area 30. For this purpose it is necessary that focal area 31 moves across working area 30 with sufficient speed. Various known technologies lend themselves to this end. Thus path movement 32 may be effected by scanner mirrors, known as Galvo scanners, introduced into the beam path of the laser radiation, which allow for a freely programmable path movement 32 at a high speed. Furthermore, optical systems on the basis of moving wedge plates, known as trepanning lenses from the field of laser drilling, or other moving optical elements such as roof mirrors, mirrors or special lenses for guiding and deflecting beams may be used. FIG. 4 shows a schematic representation of a working area 30 having a non-homogeneous intensity distribution 40, in which a focal area 31 is moved along a freely selectable path movement 32. For this purpose, path movement 31 is selected to be such that within working area 30 a region of high average intensity 41 and a region of comparatively lower average intensity 42 are formed. Intensity distribution 40 is again indicated by the density of the represented dots.

Intensity distribution 40 may be specified freely in accordance with the joining task. In this connection there is the possibility of modifying the distribution of the intensity across working area 40 online while working. Working area 40 as well as intensity distribution 40 across working area 40 may be adapted at any time during the welding process. This makes it possible to build a control loop in which using suitable sensors it is possible to detect the conditions in working area 40, for example the temperature distribution or the flow in the welding bath or the gap position or the edge quality of mating parts 15.1, 15.2, and it is possible, on the basis of these measurements, to adapt intensity distribution 40 always in an optimized manner to the boundary conditions of the process, which contributes towards stabilizing the welding process. Imperfections may be removed by the control process. If a gap opens up for example between two mating parts 15.1, 15.2 in the butt joint, intensity distribution 40 may be designed in such a way that the two mating parts 15.1, 15.2 are irradiated more strongly than the gap. The developing melt is thus able to close the gap without the laser radiation breaking through, as may happen in known laser welding systems 10, 20.

The method is advantageous in that an optical construction makes it possible to implement the most varied intensity distributions 40, which saves substantial costs in comparison to known system if different processes are to be carried out using one system and the parameters are to be varied accordingly in order to achieve optimized results in each case.

By a suitable optical construction it is not only possible to set intensity distribution 40 within the plane of working area 30, but also intensity distribution 40 in the propagation direction of the laser radiation, that is, into the depth of mating parts 15.1, 15.2. This may be achieved for example by shifting the focal position in the direction of the propagation of the laser radiation using a focusing lens, which is moved accordingly by an appropriate drive. A piezo actuator may be used as a drive for example. The system makes it possible specifically to set a three-dimensional intensity distribution 40. Thus it is possible for example to guide focal area 31 across the surface of a developing keyhole such that it is possible to work at each working location with an optimized focal position and a corresponding intensity distribution 40.

The possibility of moving the focal position in the propagation direction of the laser radiation makes it furthermore possible to vary the diameter of focal area 31 and thus the irradiation level within focal area 31 in order to create and ensure the most favorable conditions for the process.

FIG. 5 shows a schematic representation of another working area 30 having a non-homogeneous intensity distribution 40 as is again indicated by the density of the displayed dots. Working area 30 is moved in accordance with a movement direction 18 along a joining line 16 between two mating parts 15.1, 15.2 so as to form a welding seam 17. On the basis of a movement of a focal area 31 (not shown) across working area 30, intensity distribution 40 is specified in such a way that in the front (viewed in direction of movement 18) of working area 30, a region of high average intensity is formed, while in the rear (viewed in direction of movement 18), that is, in the wake, and on the welding seam edges, a region of low average intensity 42 is formed. Such an intensity distribution 40 may be practical in cw seam welding so as to introduce more energy on the welding front. This measure allows for the creation of slim and deep seams.

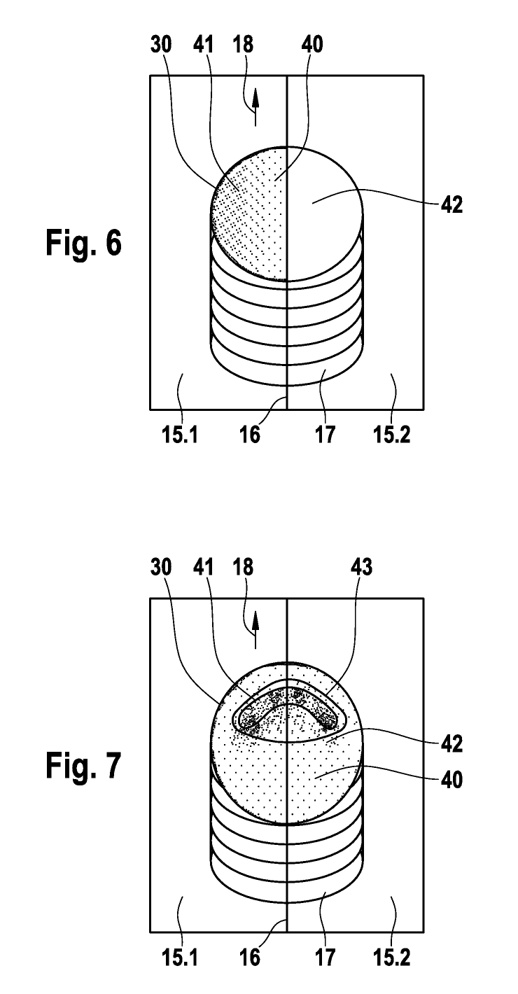

FIG. 6 shows a schematic representation of another working area 30 having a non-homogeneous intensity distribution 40. The description and the names of the represented components correspond to those in FIG. 5. In contrast to FIG. 5, in this case a region of high average intensity 41 is formed on one mating part 15.1 and a region of low average intensity 42 is formed on the other mating part 15.2. This intensity distribution 40 makes it possible, for example, to join materials of different kinds. In the exemplary embodiment shown, the material of first mating part 15.1 shown on the left requires a high average intensity 41 in order to melt, while the material of second mating part 15.2 shown on the right may only be exposed to a low average intensity 42. The method thus makes it possible to join materials of different kinds having very different properties such as melting temperature or the like. This targeted introduction of energy also makes it possible to join materials susceptible to cracking. The method makes the reproducible welding of such material combinations possible in the first place.

FIG. 7 shows a schematic representation of another working area 30 having a non-homogeneous intensity distribution 40, working area 30 deviating from a circular shape. A region of high average intensity 41 is specified to be sickle-shaped in the front section of working area 30 (viewed in the direction of movement 30), while in the rear section of working area 30, an region of low average intensity 42 is provided. Intensity distribution 40 results in the formation of a keyhole 43 having an opening that deviates from a circular geometry. The non-homogeneous specification of intensity distribution 40 thus makes it possible to determine the geometry of a developing keyhole 43 and thus optimize it with respect to the welding task. In addition to intensity distribution 40, any other intensity distributions are conceivable as well.

Adapted intensity distribution 40 makes it possible to influence the direction of flow and the rate of flow in the melting bath as well as the shape of developing keyhole 43 when deep welding. This makes it possible to stabilize the process considerably and to shape the seam in accordance with the requirements. This may be optimized further by the already described possibility of setting the focal plane along the beam axis of the laser radiation.

It is known from seam welding using additive materials that the intermixture of the melting bath is greatly influenced by the intensity distribution 40 and by the flows in the melting bath induced thereby. By adapting intensity distribution 40, the process may be optimized further in this respect as well. With respect to welding seams 17, this makes it possible for the additive material to be distributed homogeneously in the microstructure or to be specifically accumulated in certain regions in the welding bath so as to bring about certain properties in the microstructure in those regions.

1-17. (canceled)

18. A method for joining materials by laser radiation, comprising:
focusing the laser radiation on a focal area that is small compared to a working area, and a specifiable intensity distribution over the working area is achieved by moving the focus area across the working area.

19. The method as recited in claim 18, further comprising:
producing the specifiable intensity distribution over the working area by different dwell times of the focal area on sections of the machining region and/or by different intensities of the laser radiation as a function of the position of the focal area within the working area and/or by a different frequency with which the focal area is run across sections of the working area.

20. The method as recited in claim 18, further comprising:
producing working areas in an order of magnitude of 150 μm to 600 μm by focal areas of 10 μm to 100 μm, and/or working areas are produced that are greater than the focal area by a factor of at least eight.

21. The method as recited in claim 18, wherein the movement of the focal area across the working area occurs along freely specifiable paths and/or in a grid-shaped fashion.

22. The method as recited in claim 18, wherein the working area is moved along a joining line.

23. The method as recited in claim 18, wherein the movement of the focal area is effected by scanner mirrors situated in a beam path of the laser radiation and/or by moving wedge plates and/or moving roof mirrors and/or by moving lenses.

24. The method as recited in claim 18, wherein the movement of focal area across the working area occurs at such a speed that an intensity distribution that is approximately stationary for the process is achieved across the working area.

25. The method as recited in claim 18, wherein the focus of the laser radiation may be adjusted along the propagation direction of the laser radiation.

26. The method as recited in claim 18, wherein the laser radiation is focused on the surface of a developing keyhole.

27. The method as recited in claim 18, wherein the size of the focal area is configurable.

28. The method as recited in claim 18, wherein in a front section of the working area, viewed in the direction of movement of the working area, a high intensity of the laser radiation is set.

29. The method as recited in claim 18, wherein the intensity distribution is set in such a way that a geometry of a developing keyhole is formed that is optimized for the welding task.

30. The method as recited in claim 18, wherein the intensity distribution over the working area is set in such a way that a high intensity of laser radiation acts on one mating part and a low intensity of laser radiation acts on a second mating part.

31. The method as recited in claim 18, wherein the intensity distribution over the working area is set in such a way that a melting bath intermixture is specifically set.

32. The method as recited in claim 18, wherein the intensity distribution is set in the context of a control loop on the basis of measured conditions in the working area.

33. The method as recited in claim 32, wherein a melting bath flow and/or gap widths between mating parts are taken into account as conditions in the working area.

34. A device for joining materials by laser radiation, wherein a focal area of the laser radiation, which is small compared to a working area, is movable across the working area and a disk laser or a fiber laser is provided as the source of radiation.

35. The method as recited in claim 18, further comprising:
producing working areas in an order of magnitude of 150 μm to 600 μm by focal areas of 10 μm to 20 μm and/or working areas are produced that are greater than the focal area by a factor of at least eight.
